(19) United States
(12) Patent Application Publication
(10) Pub. No.: US 2013/0021391 A1
(43) Pub. Date: Jan. 24, 2013

(54) 2D and 3D Compatible Receiving Device and Receiving Method of the Same

(71) Applicant: Ming-Zhao Rui, Xiamen Torch Hi-Tech I. D. Zone (CN)

(72) Inventor: Ming-Zhao Rui, Xiamen Torch Hi-Tech I. D. Zone (CN)

(21) Appl. No.: 13/546,046

(22) Filed: Jul. 11, 2012

(30) Foreign Application Priority Data
Jul. 18, 2011 (CN) 201110200673.8

(51) Int. Cl. G09G 3/36; G09G 5/10

(52) U.S. Cl. 345/691; 345/87

(57) ABSTRACT

A 2D and 3D compatible receiving device includes a signal receiving module, a signal process module, an adjustable receiving mode module, a left shutter control module, a right shutter control module, a left shutter, a right shutter and a receiving mode status display so as to allow the user to freely view a 3D or a 2D content without change to the exterior display.

### FIELD OF THE INVENTION

The invention relates to a 3D and 2D compatible receiving device and, more particularly, to a receiving device capable of receiving 2D and 3D images without any change to the device. Furthermore, a 2D and 3D image receiving method is also disclosed in the invention.

### BACKGROUND OF THE INVENTION

Currently, there are two primary categories of technology for watching 3D images, namely, a pair of specially designed glasses and naked eyes. After considering the market trend and cost effectiveness, the specially designed eye glasses is much more popular than the naked eyes. The 3D image display technology primarily includes three types, i.e., anaglyphic 3D, polarization 3D and active shutter 3D. Among the three technologies, the polarization 3D and active shutter 3D are mostly adopted for their great effect.

The principle and technology involved in the 3D image display include the following understanding. At the time when the exterior display device displays an image for the left eye, the 3D eye glasses will open the left shutter and shut off the right shutter, e.g., blindfolding the audience's right eye. Then, the exterior display device displays an image for the right eye, the 3D eye glasses will open the right shutter and shut off the left shutter, e.g., blindfolding the audience's left eye. During which, the period for the left eye watching the image is defined as T left, i.e., the timeframe for left shutter on the 3D eye glasses opens and the period for the right eye watching the image is defined as the T right, i.e., the timeframe for right shutter on the 3D eye glasses opens. The process of switching from the left eye to the right eye is repeatedly and fast, up to 120 times per second. Therefore, it is impossible for the user to feel the difference between the switches. As a result, as long as the images for the left eye and for the right eye are correct, the user is able to see a 3D image.

The switch from the left eye to the right eye and from the right eye back to the left eye is controlled by the exterior display device via sending radio synchronous controlling signal to the 3D eye glasses to complete synchrony between the 3D eye glasses and the exterior display device. As shown in FIG. 1, the wave pattern of the radio synchronous controlling signal from the exterior display device corresponds to the T right period and T right period respectively.

Therefore, when the user chooses 3D display mode, the display will then feed in 3D image. Users wearing 3D eyeglasses are able to see three dimensional images. However, if a user is watching the display with his/her naked eyes when the display is feeding in three dimensional images, due to the differences between the image for the left eye and image for the right eye, the user will only be able to see images with shades. That is, under the three dimensional mode, only users wearing the specially designed eyeglasses can see the three dimensional images and others without the eyeglasses cannot see a clear image with the naked eye, not even a 2D image. Furthermore, due to technology limit, if a user is watching the three dimensional content for a long period of time, the user may easily feel sick and dizzy, which will definitely influence other viewers watching the 3D content at the same time. In all, the current existing 3D display and receiving device cannot display 3D and 2D content at the same time.

### SUMMARY OF THE INVENTION

The primary objective of the present invention is to provide a 3D and 2D compatible receiving device capable of presenting three dimensional and two dimensional content at the same time.

Another objective of the present invention is to provide a method for displaying 3D and 2D images from the same display to allow users wearing the 3D eyeglasses to see three dimensional content and to users without the specially designed eyeglasses to see regular two dimensional images simultaneously.

In order to accomplish the objectives of the present invention, the receiving device constructed in accordance with the present invention includes a signal receiving module, a signal process module, an adjustable receiving mode module, a left shutter control module, a right shutter control module, a left shutter, a right shutter and a receiving mode status display.

The signal receiving module is to receive radio synchronous controlling signal sent by the exterior display and transform the received signal to electronic signal and then the electrical signal is sent to the signal process module.

The signal process module is a systematic signal processing module. Mainly it is used to receive electronic signal from the signal receiving module and receiving mode adjusting command from the adjustable receiving mode module. Either the electrical signal or the receiving mode adjusting command is being processed and a 3D eyeglasses receiving mode controlling signal is sent to the left shutter control module and right shutter control module.

The receiving mode status display is to display the receiving mode after the 3D eyeglasses receiving mode controlling signal is received.

The left shutter control module is to control the left shutter module, receive controlling signal from the signal process module and to control the open and close of the left shutter so as to allow the user to watch images in the T left period or T right period from the user's left eye.

The right shutter control module is to control the right shutter module, receive controlling signal from the signal process module and to control the open and close of the right shutter so as to allow the user to watch images in the T left period or T right period from the user's right eye.

The left shutter is a liquid crystal shutter to control the open and close the shutter module corresponding to the user's left eye.

The right shutter is a liquid crystal shutter to control the open and close the shutter module corresponding to the user's right eye.

The input of the signal process module is connected to the signal receiving module and adjustable receiving mode module and the output of the signal process module is connected to the input of the left shutter control module and the right shutter control module respectively. The output of the left shutter control module is connected to the left shutter and the output of the right shutter control module is connected to the right shutter. In addition, the output of the signal process module is connected to the receiving module status display.

The adjustable receiving mode module is a mechanical button to mechanically adjust the receiving mode or an electronic sensing way to adjust the receiving mode. Either the mechanical way or the electronic way of adjusting the receiving mode is well known in the art and thus detailed description thereof is thus omitted for brevity.

The receiving mode status display may be an LED indicator, an LED array or an LED display.

The method for displaying 3D and 2D images on a pair of 3D eyeglasses is completed by two kinds of adjustments. The first adjustment is that the signal receiving module receives the radio synchronous controlling signal from the exterior display and transforms the received signal into an electronic signal for the signal process module. After the signal process module receives the electronic signal, the electronic signal is processed to become controlling signal for the left shutter control module and the right shutter control module respectively. The left shutter control module and the right shutter control module respectively control the left shutter and the right shutter according to the nature of the received controlling signal to allow the user's left eye to see images sent by the exterior display within T left period and images for the right eye sent by the exterior display within the T right period.

The second adjustment is that when manual adjustment of the adjustable receiving mode module is necessary, the adjustable receiving mode module sends a command to the signal process module. After receiving the command, the signal process module adjusts receiving mode parameters internally and then sends out a corresponding controlling signal to the left shutter control module and the right shutter control module respectively. The left shutter control module and the right shutter control module control the left shutter and the right shutter so as to allow the user's left eye to see images sent by the exterior display within the T left period and the user's right eye to see images for the right eye within T right period.

Apparently, the two procedures mentioned above can be concluded as that the signal process module sends out a controlling signal to the receiving mode status display. The receiving mode status display will then display the receiving mode in real time.

There are four different receiving modes involved in the present invention:

1. The signal receiving module receives radio synchronous controlling signal from the exterior display and transform the received signal to electronic signal and then the electrical signal is sent to the signal process module. According to the received electronic signal, the signal process module controls the left shutter control module to open the left shutter within the T left period under the radio synchronous control signal. Meanwhile, the user's left eye receives images from the exterior display within the T left period with the right shutter remained closed. This technique is the current 3D receiving technology. Under such a receiving mode, the user's left eye receives images within the T left period under the influence of the radio synchronous controlling signal and the user's right eye receives images within the T right period under the influence of the radio synchronous controlling signal. That is, the user's left eye and right eye respectively receive different images with the T left period and the T right period. After process by the human brain, the combination of these different images is put together to reveal three dimensional effect.

2. The signal receiving module receives radio synchronous controlling signal sent by the exterior display and transform the received signal to electronic signal and then the electrical signal is sent to the signal process module. According to the received electronic signal, the signal process module controls the right shutter control module to open the right shutter within the T left period under the radio synchronous control signal. Meanwhile, the user's right eye receives images from the exterior display within the T left period with the left shutter remained closed. When the radio synchronous controlling signal enters next T right period, the signal process module controls the left shutter control module to open the left shutter. The user's left eye receives images from the exterior display within the T right period with the right shutter remained closed.

This technique is still the current 3D receiving technology. Under such a receiving mode, the user's left eye receives images within the T right period under the influence of the radio synchronous controlling signal and the user's right eye receives images within the T left period under the influence of the radio synchronous controlling signal. That is, the user's left eye and right eye respectively receive different images with the T right period and the T left period. After being processed by the human brain, the combination of these different images is put together to reveal three dimensional effect. This way, problems such as images that need to be set on the exterior display to switch are solved and receiving errors for 3D content are prevented.

3. The signal receiving module receives radio synchronous controlling signal sent by the exterior display and transform the received signal to electronic signal and then the electrical signal is sent to the signal process module. According to the received electronic signal, the signal process module controls the left shutter control module and the right shutter control module to simultaneously open the left and right shutters within the T left period under the radio synchronous control signal. Meanwhile, the user's left and right eyes receive images from the exterior display within the T left period. When the radio synchronous controlling signal enters next T right period, the signal process module controls the left shutter control module as well as the right shutter control module to close the left shutter and the right shutter simultaneously. The user's left eye as well as right eye is then blindfolded. Under such a receiving mode, within the T left period, both the left shutter and the right shutter are opened to allow the user's both eyes to receive images from the exterior display. When it comes to the next T right period, both the left shutter and the right shutter are closed simultaneously and the user's both eyes are prevented from receiving any images sent by the exterior display, which effectively and successfully implements the switch between 3D and 2D images on the receiving device without any change to the exterior display.

4. The signal receiving module receives radio synchronous controlling signal sent by the exterior display and transform the received signal to electronic signal and then the electrical signal is sent to the signal process module. According to the received electronic signal, the signal process module controls the left shutter control module and the right shutter control module to simultaneously close the left and right shutters within the T left period under the radio synchronous control signal. Meanwhile, the user's left and right eyes are prevented from images sent by the exterior display within the T left period. When the radio synchronous controlling signal enters next T right period, the signal process module controls the left shutter control module as well as the right shutter control module to open the left shutter and the right shutter simultaneously. The user's left eye as well as right eye is then free of receiving images from the exterior display. Under such a receiving mode, within the T left period, both the left shutter and the right shutter are closed not to allow the user's both eyes to receive images from the exterior display. When it comes to the next T right period, both the left shutter and the right shutter are opened simultaneously and the user's both eyes are able to see images sent by the exterior display, which effectively and successfully implements the switch between 3D and 2D images on the receiving device without any change to the exterior display.

There are thus four different receiving modes involved in the present invention. When the user wishes to receive a three dimensional content, the user may choose receiving mode 1 or 2. And when the user wishes to receive a two dimensional content, the user may choose receiving mode 3 or 4. As a result, the user may select whatever receiving mode he/she wishes to receive using the same display.

Without any change to the exterior display, the user may select a 2D or 3D content using the receiving device of the present invention. Meantime, users using the same display may watch a 2D or 3D content simultaneously without any change to the exterior display.

### BRIEF DESCRIPTION OF THE DRAWINGS

FIG. 1 is a schematic wave pattern of the radio synchronous control signal of the present invention;

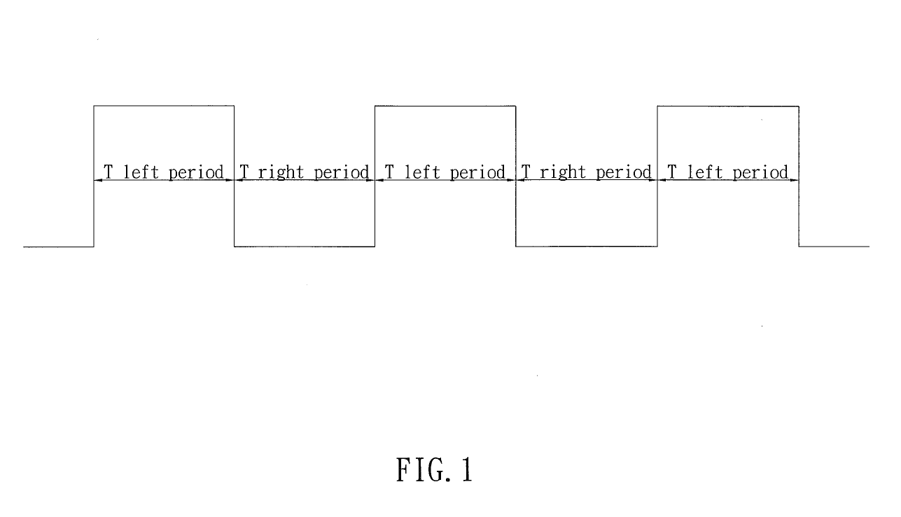

FIG. 2 is a schematic view of the adjustable shutter 3D and 2D compatible receiving device of the present invention; and

FIG. 3 is a flow chart showing the receiving modes involved in the preset invention.

### DETAILED DESCRIPTION OF THE INVENTION

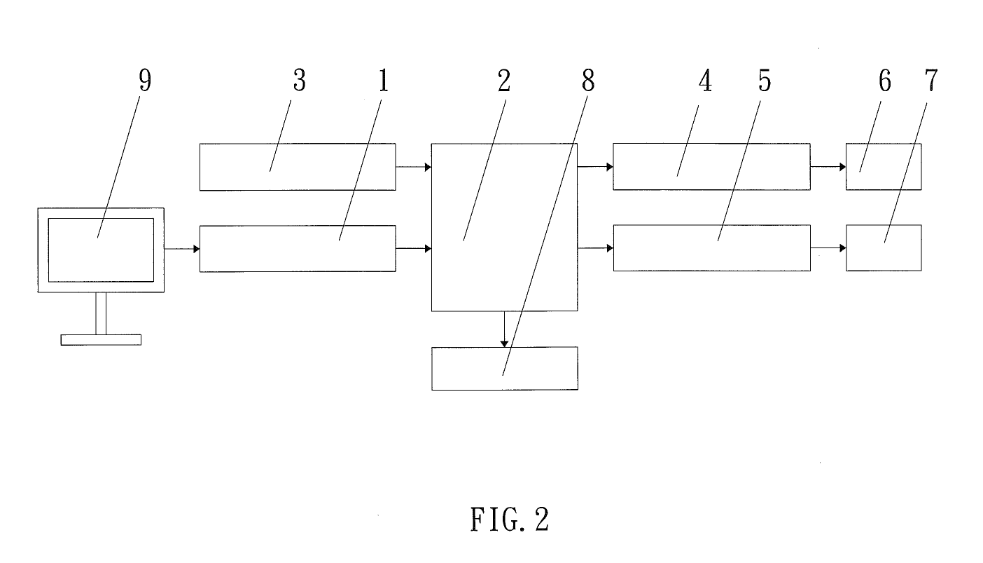

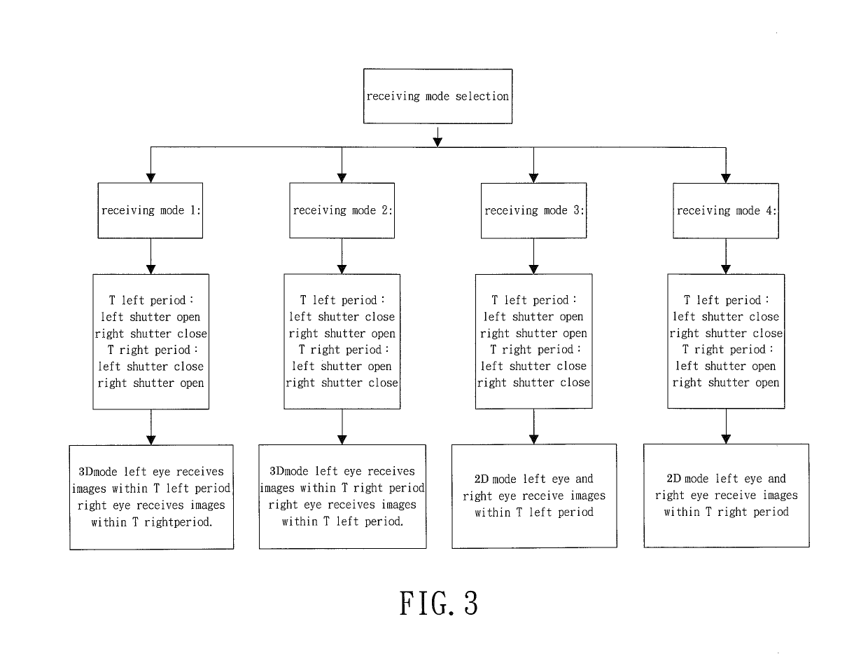

As shown in FIGS. 2 and 3, the receiving device constructed in accordance with the present invention is mounted on a pair of specially designed three dimensional eyeglasses, which includes a signal receiving module 1, a signal process module 2, adjustable receiving mode module 3, left shutter control module 4, right shutter control module 5, left shutter 6, right shutter 7 and receiving mode status display 8. The input of the signal process module 2 is connected to the signal receiving module 1 and the adjustable receiving mode module 3 and the output of the signal process module 2 is connected to the inputs of the left shutter control module 4 and the right shutter control module 5 respectively. The output of the left shutter control module 4 is connected to the left shutter 6 and the output of the right shutter control module 5 is connected to the right shutter. In addition, the output of the signal process module 2 is connected to the receiving mode status display 8.

The receiving mode status display 8 may be an LED indicator, an LED array or an LED display.

The method for displaying 3D and 2D images on a pair of 3D eyeglasses is completed by two kinds of adjustments. The first adjustment is that the signal receiving module 1 receives the radio synchronous controlling signal from the exterior display 9 and transforms the received signal into an electronic signal for the signal process module 2. After the signal process module 2 receives the electronic signal, the electronic signal is processed to become controlling signal for the left shutter control module 4 and the right shutter control module 5 respectively. The left shutter control module 4 and the right shutter control module 5 respectively control the left shutter 6 and the right shutter 7 according to the nature of the received controlling signal to allow the user's left eye to see images sent by the exterior display 9 within T left period and images for the right eye sent by the exterior display 9 within the T right period.

The second adjustment is that when manual adjustment of the adjustable receiving mode module 3 is necessary, the adjustable receiving mode module 3 sends a command to the signal process module 2. After receiving the command, the signal process module 2 adjusts receiving mode parameters internally and then sends out a corresponding controlling signal to the left shutter control module 4 and the right shutter control module 5 respectively. The left shutter control module 4 and the right shutter control module 5 control the left shutter 6 and the right shutter 7 so as to allow the user's left eye to see images sent by the exterior display 9 within the T left period and the user's right eye to see images for the right eye within T right period.

Apparently, the two procedures mentioned above can be concluded as that the signal process module 2 sends out a controlling signal to the receiving mode status display 8. The receiving mode status display 8 will then display the receiving mode in real time.

There are four different receiving modes implemented in the present invention:

1. (3D mode) The signal receiving module 1 receives radio synchronous controlling signal from the exterior display 9 and transform the received signal to electronic signal and then the electrical signal is sent to the signal process module 2. According to the received electronic signal, the signal process module 2 controls the left shutter control module 4 to open the left shutter 6 within the T left period under the radio synchronous control signal. Meanwhile, the user's left eye receives images from the exterior display 9 within the T left period with the right shutter 7 remained closed. Under the same receiving mode, the user's right eye receives images within the T right period under the influence of the radio synchronous controlling signal while the left shutter 6 is remained closed. That is, the user's left eye and right eye respectively receive different images within the T left period and the T right period from the exterior display 9. After process by the human brain, the combination of these different images is put together to reveal three dimensional effect.

2. (3D mode) The signal receiving module 1 receives radio synchronous controlling signal sent by the exterior display 9 and transform the received signal to electronic signal and then the electrical signal is sent to the signal process module 2. According to the received electronic signal, the signal process module 2 controls the right shutter control module 5 to open the right shutter 7 within the T left period under the radio synchronous control signal. Meanwhile, the user's right eye receives images from the exterior display 9 within the T left period with the left shutter 6 remained closed. When the radio synchronous controlling signal enters next T right period, the signal process module 2 controls the left shutter control module 4 to open the left shutter 6. The user's left eye receives images from the exterior display 9 within the T right period with the right shutter 7 remained closed.

This technique is still the current 3D receiving technology. Under such a receiving mode, the user's left eye receives images within the T right period under the influence of the radio synchronous controlling signal and the user's right eye receives images within the T left period under the influence of the radio synchronous controlling signal. That is, the user's left eye and right eye respectively receive different images with the T right period and the T left period. After being processed by the human brain, the combination of these different images is put together to reveal three dimensional effect. This way, problems such as images that need to be set on the exterior display 9 to switch are solved and receiving errors for 3D content are prevented.

3. (2D mode) The signal receiving module 1 receives radio synchronous controlling signal sent by the exterior display 9 and transform the received signal to electronic signal and then the electrical signal is sent to the signal process module 2. According to the received electronic signal, the signal process module 2 controls the left shutter control module 4 and the right shutter control module 5 to simultaneously open the left and right shutters 6,7 within the T left period under the radio synchronous control signal. Meanwhile, the user's left and right eyes receive images from the exterior display 9 within the T left period. When the radio synchronous controlling signal enters next T right period, the signal process module 2 controls the left shutter control module 4 as well as the right shutter control module 5 to close the left shutter 6 and the right shutter 7 simultaneously. The user's left eye as well as right eye is then blindfolded. Under such a receiving mode, within the T left period, both the left shutter 6 and the right shutter 7 are opened to allow the user's both eyes to receive images from the exterior display 9. When it comes to the next T right period, both the left shutter 6 and the right shutter 7 are closed simultaneously and the user's both eyes are prevented from receiving any images sent by the exterior display 9, which effectively and successfully implements the switch between 3D and 2D images on the receiving device without any change to the exterior display.

4. (2D mode) The signal receiving module 1 receives radio synchronous controlling signal sent by the exterior display 9 and transform the received signal to electronic signal and then the electrical signal is sent to the signal process module 2. According to the received electronic signal, the signal process module 2 controls the left shutter control module 4 and the right shutter control module 5 to simultaneously close the left and right shutters 6,7 within the T left period under the radio synchronous control signal. Meanwhile, the user's left and right eyes are prevented from images sent by the exterior display 9 within the T left period. When the radio synchronous controlling signal enters next T right period, the signal process module 2 controls the left shutter control module 4 as well as the right shutter control module 5 to open the left shutter 6 and the right shutter 7 simultaneously. The user's left eye as well as right eye is then free of receiving images from the exterior display. Under such a receiving mode, within the T left period, both the left shutter 6 and the right shutter 7 are closed not to allow the user's both eyes to receive images from the exterior display 9. When it comes to the next T right period, both the left shutter 6 and the right shutter 7 are opened simultaneously and the user's both eyes are able to see images sent by the exterior display 9, which effectively and successfully implements the switch between 3D and 2D images on the receiving device without any change to the exterior display.

There are thus four different receiving modes involved in the present invention. When the user wishes to receive a three dimensional content, the user may choose receiving mode 1 or 2. And when the user wishes to receive a two dimensional content, the user may choose receiving mode 3 or 4. As a result, the user may select whatever receiving mode he/she wishes to receive using the same display.

Without any change to the exterior display, the user may select a 2D or 3D content using the receiving device of the present invention. Meantime, users using the same display may watch a 2D or 3D content simultaneously without any change to the exterior display 9.

It is to be noted that although the preferred embodiment of the present invention has been described, other modifications, alterations or minor change to the structure should still be within the scope defined in the claims. As those skilled in the art will readily observe that numerous modifications and alterations of the device and method may be made while retaining the teachings of the invention.

What is claimed is:

1. A 2D and 3D compatible receiving device which is mounted on a pair of 3D eyeglasses, comprising:
a signal receiving module, a signal process module, an adjustable receiving mode module, a left shutter control module, a right shutter control module, a left shutter, a right shutter and a receiving mode status display, wherein:
the signal receiving module is to receive radio synchronous controlling signal sent by an exterior display and transform the received signal to an electronic signal and then the electrical signal is sent to the signal process module;
the signal process module is a systematic signal processing module to receive electronic signal from the signal receiving module and receive a mode adjusting command from the adjustable receiving mode module so that a 3D eyeglasses receiving mode controlling signal is sent to the left shutter control module and right shutter control module;
the receiving mode status display is to display current receiving mode after the 3D eyeglasses receiving mode controlling signal is received;
the left shutter control module is to control the left shutter module, receive controlling signal from the signal process module and to control open and close of the left shutter so as to allow a user to watch images in T left period or T right period from the user's left eye;
the right shutter control module is to control the right shutter module, receive controlling signal from the signal process module and to control open and close of the right shutter so as to allow the user to watch images in the T left period or T right period from the user's right eye;
the left shutter is a liquid crystal shutter to control open and close command from the left shutter control module;
the right shutter is a liquid crystal shutter to control open and close command from the right shutter control module;
input of the signal process module is connected to the signal receiving module and adjustable receiving mode module and output of the signal process module is connected to input of the left shutter control module and the right shutter control module respectively, output of the left shutter control module is connected to the left shutter and output of the right shutter control module is connected to the right shutter, the output of the signal process module is connected to the receiving module status display.

2. The receiving device as claimed in claim 1, wherein the adjustable receiving mode module is a mechanical button to mechanically adjust receiving mode or an electronic sensing to adjust the receiving mode.

3. The receiving device as claimed in claim 1, wherein the receiving mode status display is an LED indicator, an LED array or an LED display.

4. A method for displaying 3D and 2D images on a pair of 3D eyeglasses by using the receiving device as claimed in claim 1, the method comprising the steps of:
the signal receiving module receiving radio synchronous controlling signal from the exterior display and transforming the received signal into an electronic signal for the signal process module;
the electronic signal being processed to become controlling signal for the left shutter control module and the right shutter control module respectively; and
the left shutter control module and the right shutter control module respectively controlling the left shutter and the right shutter in response to nature of the received controlling signal so as to allow a user's left eye to see images sent by the exterior display within T left period and images for the right eye sent by the exterior display within T right period.

5. A method for displaying 3D and 2D images on a pair of 3D eyeglasses by using the receiving device as claimed in claim 1, the method comprising the steps of:
the adjustable receiving mode module sending a command to the signal process module;
the signal process module adjusting receiving mode parameters and then sending a corresponding controlling signal to the left shutter control module and the right shutter control module respectively; and
the left shutter control module and the right shutter control module controlling the left shutter and the right shutter so as to allow a user's left eye to see images sent by the exterior display within T left period and the user's right eye to see images for the right eye within T right period.

6. The method as claimed in claim 4, wherein the receiving mode includes four different modes, which includes:
1. the signal receiving module receiving radio synchronous controlling signal from the exterior display and transforming the received signal to electronic signal and then the electrical signal being sent to the signal process module,
the signal process module controlling the left shutter control module to open the left shutter within the T left period under the radio synchronous control signal to allow the user's left eye to receive images from the exterior display within the T left period with the right shutter remained closed, and
the signal process module controlling the right shutter control module to open the right shutter to allow the user's right eye to receive images from the exterior display within the T right period with the left shutter remained closed;
2. the signal receiving module receiving radio synchronous controlling signal sent by the exterior display and transforming the received signal to electronic signal and then the electrical signal being sent to the signal process module,
the signal process module controlling the right shutter control module to open the right shutter within the T left period under the radio synchronous control signal to allow the user's right eye receives images from the exterior display within the T left period with the left shutter remained closed, and
the signal process module controlling the left shutter control module to open the left shutter to allow the user's left eye to receive images from the exterior display within the T right period with the right shutter remained closed;
3. the signal receiving module receiving radio synchronous controlling signal sent by the exterior display and transforming the received signal to electronic signal and then the electrical signal being sent to the signal process module,
the signal process module controlling the left shutter control module and the right shutter control module to simultaneously open the left and right shutters within the T left period under the radio synchronous control signal to allow the user's left and right eyes to receive images from the exterior display within the T left period, and
the signal process module controlling the left shutter control module as well as the right shutter control module to close the left shutter and the right shutter simultaneously to blindfold the user's left eye as well as right eye in the T right period;
4. the signal receiving module receiving radio synchronous controlling signal sent by the exterior display and transforming the received signal to electronic signal and then the electrical signal being sent to the signal process module,
the signal process module controlling the left shutter control module and the right shutter control module to simultaneously close the left and right shutters within the T left period under the radio synchronous control signal to prevent the user's left and right eyes from images sent by the exterior display within the T left period, and
the signal process module controlling the left shutter control module as well as the right shutter control module to open the left shutter and the right shutter simultaneously to allow the user's left eye as well as right eye to receive images from the exterior display within the T right period.
